(19) United States
(12) Patent Application Publication
(10) Pub. No.: US 2024/0430837 A1
(43) Pub. Date: Dec. 26, 2024

(54) UPLINK TRANSMISSION METHOD, TERMINAL, AND NETWORK SIDE DEVICE

(71) Applicant: VIVO MOBILE COMMUNICATION CO., LTD., Dongguan (CN)

(72) Inventors: Rongrong SUN, Dongguan (CN); Hao LIU, Dongguan (CN); Peng SUN, Dongguan (CN); Yang SONG, Dongguan (CN); Rakesh TAMRAKAR, Dongguan (CN)

(73) Assignee: VIVO MOBILE COMMUNICATION CO., LTD., Dongguan (CN)

(21) Appl. No.: 18/826,378

(22) Filed: Sep. 6, 2024

Related U.S. Application Data
(63) Continuation of application No. PCT/CN2023/080279, filed on Mar. 8, 2023.

(30) Foreign Application Priority Data
Mar. 9, 2022 (CN) 202210234176.8
Oct. 13, 2022 (CN) 202211255663.9

(51) Int. Cl. H04W 56/00; H04W 72/231

(52) U.S. Cl. CPC H04W 56/0045; H04W 72/231

(57) ABSTRACT

This application discloses an uplink transmission method, a terminal, and a network side device. The uplink transmission method includes: receiving radio resource control (RRC) signaling, where the RRC signaling includes configuration information of a target timing advance group (TAG), where the configuration information of the target TAG includes a plurality of sets of timing advance (TA) configuration-related information associated with different target objects, where each target object includes a transmission configuration indicator (TCI) state; and adjusting, based on a first target timing advance command (TAC), timing of a target uplink transmission corresponding to a first target TCI state, where the first target TAC is associated with the first target TCI state.

### CROSS-REFERENCE TO RELATED APPLICATIONS

This application is a continuation of International Application No. PCT/CN2023/080279, filed Mar. 8, 2023, which claims priority to Chinese Patent Application No. 202210234176.8, filed Mar. 9, 2022, and claims priority to Chinese Patent Application No. 202211255663.9, filed Oct. 13, 2022. The entire contents of each of the above-referenced applications are expressly incorporated herein by reference.

### TECHNICAL FIELD

This application relates to the field of communication technologies, and specifically relates to an uplink transmission method, a terminal, and a network side device.

### BACKGROUND

In a related technology, for a plurality of different objects (for example, a beam, a Sounding Reference Signal (SRS) resource, an antenna group, and a Transmitting Receiving Point (TRP)), a plurality of uplink transmissions performed by a terminal usually use a same Timing Advance (TA). However, for reasons such as a large difference in locations of different objects, interference between users exists between some uplink transmissions, and uplink transmission performance is reduced.

### SUMMARY

Embodiments of this application provide an uplink transmission method, a terminal, and a network side device, so that interference between users can be avoided, and uplink transmission performance can be improved.

According to a first aspect, an uplink transmission method is provided. The method includes: A terminal adjusts timing of a target uplink transmission based on a target manner and/or a timing advance (TA) adjustment granularity. The target manner includes at least one of the following: adjusting, based on a first target timing advance command TAC, timing of a target uplink transmission corresponding to a first target object; or adjusting, based on a downlink time difference and the first target TAC, timing of a target uplink transmission corresponding to a second target object. The downlink time difference is a difference between first downlink transmission timing and second downlink transmission timing. The first downlink transmission timing is time at which the terminal receives a downlink transmission corresponding to the first target object. The second downlink transmission timing is time at which the terminal receives a downlink transmission corresponding to the second target object. The first target TAC is associated with the first target object.

According to a second aspect, an uplink transmission method is provided. The method includes: A network side device sends a media access control control unit MAC CE. The MAC CE includes at least one of the following: a first target timing advance command TAC, where the first target TAC is associated with a first target object; or an identifier of the first target object.

According to a third aspect, an uplink transmission apparatus is provided. The apparatus includes: an adjustment module, configured to adjust timing of a target uplink transmission based on a target manner and/or a timing advance TA adjustment granularity. The target manner includes at least one of the following: adjusting, based on a first target timing advance command TAC, timing of a target uplink transmission corresponding to a first target object; or adjusting, based on a downlink time difference and the first target TAC, timing of a target uplink transmission corresponding to a second target object. The downlink time difference is a difference between first downlink transmission timing and second downlink transmission timing. The first downlink transmission timing is time at which the terminal receives a downlink transmission corresponding to the first target object. The second downlink transmission timing is time at which the terminal receives a downlink transmission corresponding to the second target object. The first target TAC is associated with the first target object.

According to a fourth aspect, an uplink transmission apparatus is provided. The apparatus includes: a first transmission module, configured to send a media access control control unit MAC CE. The MAC CE includes at least one of the following: a first target timing advance command TAC, where the first target TAC is associated with a first target object; or an identifier of the first target object.

According to a fifth aspect, a terminal is provided. The terminal includes a processor and a memory. The memory stores a program or an instruction that can be run on the processor. When the program or the instruction is executed by the processor, the steps of the method according to the first aspect are implemented.

According to a sixth aspect, a terminal is provided. The terminal includes a processor and a communication interface. The communication interface is coupled to the processor. The processor is configured to run a program or an instruction to implement the steps of the method according to the first aspect.

According to a seventh aspect, a network side device is provided. The network side device includes a processor and a memory. The memory stores a program or an instruction that can be run on the processor. When the program or the instruction is executed by the processor, the steps of the method according to the second aspect are implemented.

According to an eighth aspect, a network side device is provided. The network side device includes a processor and a communication interface. The communication interface is coupled to the processor. The processor is configured to run a program or an instruction to implement the steps of the method according to the second aspect.

According to a ninth aspect, a wireless communication system is provided. The wireless communication system includes a terminal and a network side device. The terminal may be configured to perform the steps of the uplink transmission method according to the first aspect, and the network side device may be configured to perform the steps of the uplink transmission method according to the second aspect.

According to a tenth aspect, a readable storage medium is provided. The readable storage medium stores a program or an instruction. When the program or the instruction is executed by a processor, the steps of the method according to the first aspect or the steps of the method according to the second aspect are implemented.

According to an eleventh aspect, a chip is provided. The chip includes a processor and a communication interface. The communication interface is coupled to the processor. The processor is configured to run a program or an instruction to implement the steps of the method according to the first aspect or implement the steps of the method according to the second aspect.

According to a twelfth aspect, a computer program product/program product is provided. The computer program/program product is stored in a storage medium. The computer program/program product is executed by at least one processor to implement the steps of the method according to the first aspect or the steps of the method according to the second aspect.

In embodiment of this application, the terminal adjusts the timing of the target uplink transmission based on the target manner and/or the TA adjustment granularity. The target manner includes: adjusting, based on a first target TAC, the timing of the target uplink transmission corresponding to the first target object; and/or adjusting, based on the downlink time difference and the first target TAC, the timing of the target uplink transmission corresponding to the second target object. In this way, different target objects use different TAs to adjust uplink transmission timing, to ensure accurate and efficient adjustment of the uplink transmission timing, so as to ensure that uplink transmission timing corresponding to each target object meets an orthogonal relationship between users, avoid interference between the users, and improve uplink transmission performance. In addition, adjusting the timing of the target uplink transmission based on the TA adjustment granularity can avoid problems of high terminal power consumption and high signaling overheads caused by frequent adjustment, and can also reduce complexity of terminal implementation.

### BRIEF DESCRIPTION OF DRAWINGS

FIG. 1 is a schematic diagram of a structure of a wireless communication system according to an example embodiment of this application;

FIG. 2 is a flowchart of an uplink transmission method according to an example embodiment of this application;

FIG. 3 is a flowchart of an uplink transmission method according to another example embodiment of this application;

FIG. 4a is a schematic diagram of adjusting timing of a target uplink transmission based on a same TA process according to an example embodiment of this application;

FIG. 4b is a schematic diagram of periodically adjusting timing of a target uplink transmission according to an example embodiment of this application;

FIG. 4c is a schematic diagram of periodically adjusting timing of a target uplink transmission according to another example embodiment of this application;

FIG. 4d is a schematic diagram of adjusting timing of a target uplink transmission based on different TA processes according to another example embodiment of this application;

FIG. 4e is a schematic diagram of adjusting timing of a target uplink transmission based on a downlink time difference and a first target TAC according to an example embodiment of this application;

FIG. 4f is a schematic diagram of adjusting timing of a target uplink transmission based on a downlink time difference and a first target TAC according to another example embodiment of this application;

FIG. 5 is a flowchart of an uplink transmission method according to still another example embodiment of this application;

FIG. 6 is a schematic diagram of a structure of an uplink transmission apparatus according to an example embodiment of this application;

FIG. 7 is a schematic diagram of a structure of an uplink transmission apparatus according to an example embodiment of this application;

FIG. 8 is a schematic diagram of a structure of a terminal according to an example embodiment of this application; and

FIG. 9 is a schematic diagram of a structure of a network side device according to an example embodiment of this application.

### DETAILED DESCRIPTION

The following clearly describes technical solutions in embodiments of this application with reference to accompanying drawings in embodiments of this application. It is clear that the described embodiments are a part rather than all of embodiments of this application. All other embodiments obtained by a person of ordinary skill in the art based on embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” usually represents an “or” relationship between associated objects. It may be understood that the first object mentioned herein is any object that needs to be distinguished by using the terms “first” and “second”.

It is worth noting that the technologies described in embodiments of this application are not limited to a Long Term Evolution (LTE)/LTE-Advanced (LTE-A) system, and are further applicable to another wireless communication system, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or another system. The terms “system” and “network” in embodiments of this application are usually used interchangeably, and the described technology may be applied not only to the systems and radio technologies mentioned above, but also to other systems and radio technologies. The following describes a New Radio (NR) system for example purposes, and uses NR terminology in most of the description below, although these technologies are also applicable to applications other than NR system applications, such as a 6th Generation (6G) communication system.

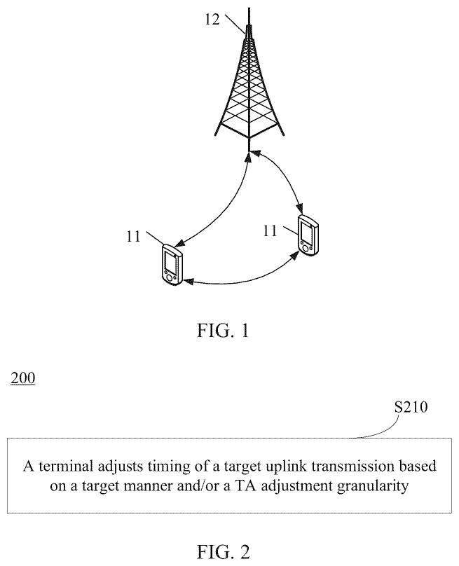

FIG. 1 is a block diagram of a wireless communication system to which embodiments of this application may be applied. The wireless communication system includes a terminal 11 and a network side device 12. The terminal 11 may be terminal side device such as a mobile phone, a tablet personal computer, a laptop computer or referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, an in-vehicle device (VUE), a pedestrian terminal (PUE), a smart home (a home device with a wireless communication function, such as a refrigerator, a television, a washing machine, or furniture), a game machine, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart anklet, a smart ankle chain, and the like), a smart wristband, smart clothing, and the like. It should be noted that a specific type of the terminal 11 is not limited in embodiments of this application. The network side device 12 may include an access network device or a core network device. An access network device 12 may also be referred to as a radio access network device, a Radio Access Network (RAN), a radio access network function, or a radio access network unit. The access network device 12 may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another suitable term in the field. Provided that the same technical effect is achieved, the base station is not limited to a specific technical term. It should be noted that a base station in an NR system is merely used as an example for description in embodiments of this application, but a specific type of the base station is not limited. The technical solutions provided in embodiments of this application are described in detail below with reference to the accompanying drawings by using some embodiments and application scenarios thereof.

FIG. 2 is a schematic flowchart of an uplink transmission method 200 according to an example embodiment of this application. The method 200 may be performed by but is not limited to a terminal, and may be performed by hardware and/or software installed in the terminal. In this embodiment, the method may include at least the following steps.

S210: The terminal adjusts timing of a target uplink transmission based on a target manner and/or a TA adjustment granularity.

The target manner includes at least one of the following manner 1 or manner 2.

Manner 1: Adjust, based on a first target Timing Advance Command (TAC), timing of a target uplink transmission corresponding to a first target object.

Manner 2: Adjusting, based on a downlink time difference and the first target TAC, timing of a target uplink transmission corresponding to a second target object. The downlink time difference is a difference between first downlink transmission timing and second downlink transmission timing. The first downlink transmission timing is time at which the terminal receives a downlink transmission corresponding to the first target object. The second downlink transmission timing is time at which the terminal receives a downlink transmission corresponding to the second target object.

In the manner 1 and manner 2, the first target TAC is associated with the first target object. It may be understood as that the first target TAC is used to notify the terminal to send the uplink transmission in advance by a corresponding time amount, for example, a Timing Advance (TA). For example, the first target TAC is used to notify the terminal of a TA corresponding to the first target object, so that the terminal can adjust, based on the TA, the uplink transmission timing corresponding to the first target object, or the terminal adjusts, based on the TA notified by the first target TAC, uplink transmission timing corresponding to a target object other than the first target object.

In an implementation, the first target object may be but is not limited to an SRS resource set, an SRS resource, a Transmission Configuration Indicator (TCI) state, a TCI state pool, an antenna group, a panel, a TRP, a resource pool index (CoresetPoolIndex), a TAG, a TAG index, or the like.

Based on this, for a scenario in which there are a plurality of target objects, a process in which the terminal adjusts the timing of the target uplink transmission based on the target manner may be as follows:

When the target manner includes the manner 1, the terminal may adjust uplink transmission timing based on target TACs that are in a one-to-one correspondence with the target objects. For example, in the foregoing, the terminal adjusts, based on the first target TAC, the timing of the target uplink transmission corresponding to the first target object. Therefore, different target objects use different TAs to adjust the uplink transmission timing, to ensure accurate and efficient adjustment of the uplink transmission timing, so as to ensure that uplink transmission timing corresponding to each target object meets an orthogonal relationship between users, avoid interference between the users, and improve uplink transmission performance. Especially when the target object is the TRP, a throughput can be improved through multiple-TRP transmission.

When the target manner includes the manner 1 and the manner 2, the terminal may adjust, based on the received first target TAC, the uplink transmission timing of the target uplink transmission corresponding to the first target object associated with the first target TAC. For another target object, other than the first target object, in the plurality of target objects, such as the second target object, the terminal may adjust, based on the first target TAC and a downlink time difference, uplink transmission timing corresponding to the another target object. Therefore, this implementation is different from the manner 1 in that when there is only one target TAC, the uplink transmission timing corresponding to the plurality of target objects can be accurately and efficiently adjusted, and terminal implementation is simple.

It may be understood that when the target manner includes only the manner 2, for its implementation process, refer to related descriptions for the case that the target manner includes the manner 1 and the manner 2. To avoid repetition, details are not described herein again.

It should be noted that, an adjustment process of the uplink transmission timing implemented based on the manner 1 and/or the manner 2 in this embodiment is different from that in a related technology in that the TAs that are one-to-one associated with (or in a one-to-one correspondence with) the target objects are used. In other words, different target objects use different TAs to adjust the uplink transmission timing. Therefore, accurate and efficient adjustment of the uplink transmission timing can be ensured, so as to ensure that the uplink transmission timing corresponding to each target object meets the orthogonal relationship between the users. In this way, a difference between time at which uplink transmissions of different users arrive at one object (such as the TRP) does not exceed a Cyclic Prefix (CP), to avoid interference between the users, and improve uplink transmission performance.

It may be understood that the first target TAC may be obtained in a plurality of manners. For example, the terminal may obtain the first target TAC by receiving a Medium Access Control Control Element (MAC CE). The MAC CE includes at least the first target Timing Advance Command (TAC). In some embodiments, the terminal may obtain the first target TAC in a manner specified in a protocol. This is not limited herein.

In an implementation, when the terminal obtains the first target TAC by using the MAC CE, the MAC CE may further carry an identifier of the first target object associated with the first target TAC. In some embodiments, if the first target TAC includes a first TAC and a second TAC, the MAC CE may further carry an identifier of a first object associated with the first TAC, an identifier of a second object associated with the second TAC, and the like. This is not limited herein.

It should be noted that if the MAC CE includes only the first target TAC, an association relationship between the first target TAC and the first target object may be implemented in a manner of protocol specification, high layer configuration, or the like. This is not limited herein.

Further, the TA adjustment granularity may be understood as a minimum interval for performing TA adjustment twice by the terminal, to avoid problems of high terminal power consumption and high signaling overheads caused by frequent adjustment, and also reduce complexity of terminal implementation.

In this embodiment, the TA adjustment granularity may be determined autonomously by the terminal or determined by the terminal based on received third Radio Resource Control (RRC) signaling, where the TA adjustment granularity is configured in the third RRC signaling. In some embodiments, if the TA adjustment granularity is determined autonomously by the terminal, the terminal may report the TA adjustment granularity to the network side device, to ensure consistency of understanding of the TA adjustment granularity between the terminal and the network side device.

In addition, a magnitude of the TA adjustment granularity may be defined according to a communication requirement. For example, for different configuration of a Subcarrier Spacing (SCS), adjustment granularities of different lengths may be defined. For example, the TA adjustment granularity may be 0.5 slots, 1 slot, 2 slots, 3 slots, or 4 slots. In some embodiments, in addition to using a slot as a time unit, the TA adjustment granularity may also use a frame, a subframe, a symbol, or the like as the time unit. This is not limited herein.

In this case, for the target manner and the TA adjustment granularity, the terminal may determine, based on a manner of protocol specification, high layer configuration, network side configuration, or the like, whether to adjust the uplink transmission timing based on the target manner, or based on the TA adjustment granularity, or based on the target manner and the TA adjustment granularity. This is not limited in this embodiment.

In this embodiment, the terminal adjusts the timing of the target uplink transmission based on the target manner and/or the TA adjustment granularity. The target manner includes: adjusting, based on the first target TAC, the timing of the target uplink transmission corresponding to the first target object; and/or adjusting, based on the downlink time difference and the first target TAC, the timing of the target uplink transmission corresponding to the second target object. In this way, different target objects use different TAs to adjust the uplink transmission timing, to ensure accurate and efficient adjustment of the uplink transmission timing, so as to ensure that the uplink transmission timing corresponding to each target object meets the orthogonal relationship between the users, avoid interference between the users, and improve uplink transmission performance. In addition, adjusting the timing of the target uplink transmission based on the TA adjustment granularity can avoid the problems of high terminal power consumption and high signaling overheads caused by frequent adjustment, and can also reduce complexity of terminal implementation.

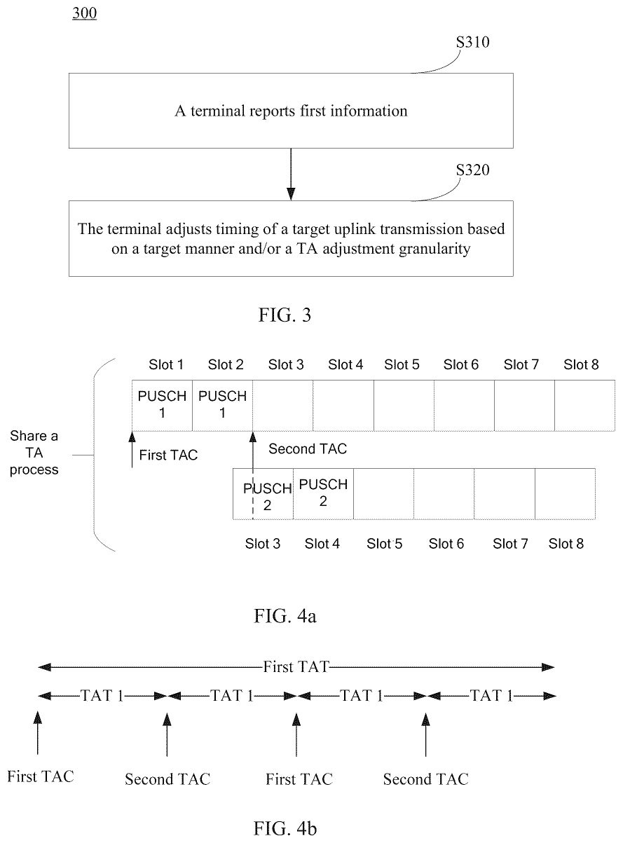

FIG. 3 is a schematic flowchart of an uplink transmission method 300 according to an example embodiment of this application. The method 300 may be performed by but is not limited to a terminal, and may be performed by hardware and/or software installed in the terminal. In this embodiment, the method may include at least the following steps.

S310: The terminal reports first information.

The first information includes at least one of the following (11) to (13).

(11) UE capability information, where the UE capability information includes that the terminal supports a TA adjustment mode corresponding to one TA, and/or the terminal supports TA adjustment modes corresponding to a plurality of TAs. In this embodiment, that the terminal supports the TA adjustment mode corresponding to the one TA may be understood as that for a plurality of target objects, the same TA is used to adjust uplink transmission timing.

That the terminal supports the TA adjustment modes corresponding to the plurality of TAs may be understood as that for the plurality of target objects, different target objects use different TAs to adjust the uplink transmission timing.

(12) A quantity of TAs preferred by the terminal, where the quantity of TAs is determined by the terminal based on downlink measurement.

(13) A downlink time difference, where the downlink time difference is determined by the terminal based on the downlink measurement.

The foregoing (12) and (13) are used to assist a network side device in indicating whether to enable the TA adjustment modes of the plurality of TAs. For example, if the quantity of TAs preferred by the terminal is 2, the network side device indicates to enable the TA adjustment modes of the plurality of TAs; otherwise, the network side does not indicate to enable the TA adjustment modes of the plurality of TAs. For another example, if the downlink time difference is greater than a predetermined value, the network side device indicates to enable the TA adjustment modes of the plurality of TAs; otherwise, the network side device does not indicate to enable the TA adjustment modes of the plurality of TAs. In this way, flexibility of a TA adjustment process can be improved.

Based on this, it may be understood that subsequent implementation of S320 is implemented when the terminal supports the TA adjustment modes of the plurality of TAs and the network side device indicates to enable the TA adjustment modes of the plurality of TAs. Details are not described again.

S320: The terminal adjusts timing of a target uplink transmission based on a target manner and/or a TA adjustment granularity.

The target manner includes at least one of the following manner 1 or manner 2.

Manner 1: Adjust, based on a first target TAC, timing of a target uplink transmission corresponding to a first target object.

Manner 2: Adjust, based on the downlink time difference and the first target TAC, timing of a target uplink transmission corresponding to a second target object. The downlink time difference is a difference between first downlink transmission timing and second downlink transmission timing. The first downlink transmission timing is time at which the terminal receives a downlink transmission corresponding to the first target object. The second downlink transmission timing is time at which the terminal receives a downlink transmission corresponding to the second target object.

The first target TAC is associated with the first target object.

It may be understood that, for an implementation process of S310, refer to the foregoing related descriptions in the method embodiment 200. In addition, in a possible implementation, the terminal may periodically adjust the timing of the target uplink transmission based on the TA adjustment granularity. For example, if the TA adjustment granularity is 0.5 slots, the terminal may adjust the timing of the target uplink transmission every 0.5 slots.

In addition, for a process in which the terminal adjusts the timing of the target uplink transmission based on the target manner, the following further describes its implementation process with reference to Example 1 and Example 2, and content is as follows:

### Example 1

It is assumed that the target manner includes the manner 1, the first target object includes a first object and a second object, and the first target TAC includes a first TAC associated with the first object and a second TAC associated with the second object. In this case, the terminal may calculate a first TA based on the first TAC, and calculate a second TA based on the second TAC; and then adjust, based on the first TA, timing of a target uplink transmission corresponding to the first object, and adjust, based on the second TA, timing of a target uplink transmission corresponding to the second object.

In some embodiments, a process in which the terminal adjusts, based on the first TA, the timing of the target uplink transmission corresponding to the first object and adjusts, based on the second TA, the timing of the target uplink transmission corresponding to the second object may include any one of the following (11) or (12).

(11) Adjust, based on downlink transmission timing corresponding to a reference object and the first TA, the timing of the target uplink transmission corresponding to the first object, and adjust, based on the downlink transmission timing corresponding to the reference object and the second TA, the timing of the target uplink transmission corresponding to the second object, where the reference object is the first object or the second object. It may be understood that, in an implementation process of (11), downlink transmission timing corresponding to the first object is the same as downlink transmission timing corresponding to the second object. In some embodiments, a difference between the downlink transmission timing corresponding to the first object and the downlink transmission timing corresponding to the second object is less than a first threshold, and a magnitude of the first threshold may be implemented through protocol specification, high layer configuration, or the like. This is not limited herein.

(12) Adjust, based on the downlink transmission timing of the first object and the first TA, the timing of the target uplink transmission corresponding to the first object, and adjust, based on the downlink transmission timing of the second object and the second TA, the timing of the target uplink transmission corresponding to the second object. It may be understood that in an implementation process of (12), the difference between the downlink transmission timing corresponding to the first object and the downlink transmission timing corresponding to the second object is greater than or equal to a second threshold, and a magnitude of the second threshold may be implemented through protocol specification or high layer configuration. This is not limited herein. In some embodiments, the first threshold and the second threshold may be the same or different.

In Example 1, for adjustment of timing of target uplink transmissions corresponding to a plurality of objects (for example, the first object and the second object), the plurality of objects may share one TA process (that is, a physical layer maintains one uplink frame (UL Frame)), and then a MAC layer maintains a plurality of TACs, so that the uplink transmissions corresponding to the plurality of objects use different TAs to adjust the uplink transmission timing. In some embodiments, the target uplink transmissions corresponding to the plurality of objects may use a plurality of independent TA processes (that is, the physical layer maintains a plurality of independent UL frames), and then the MAC layer maintains the plurality of TACs, so that the uplink transmissions corresponding to the plurality of objects use different TAs to adjust the uplink transmission timing.

Based on this, the following uses an example in which the first target object includes the first object and the second object, and the first target TAC includes the first TAC associated with the first object and the second TAC associated with the second object to describe the foregoing two cases.

### Case 1

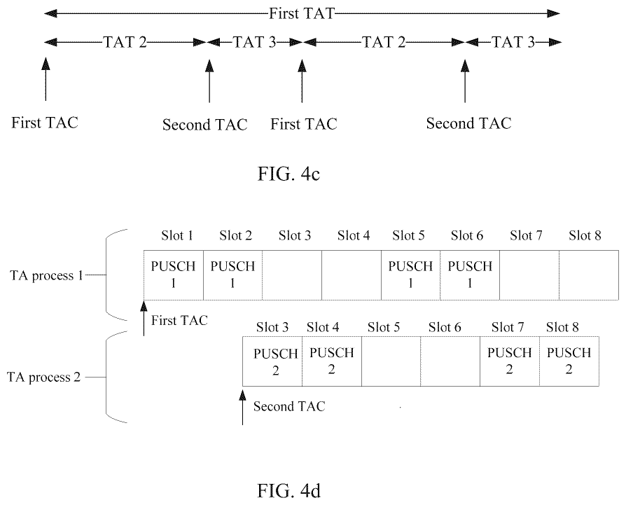

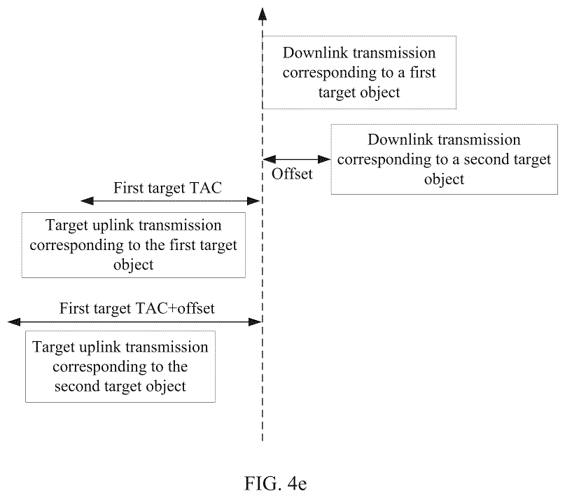

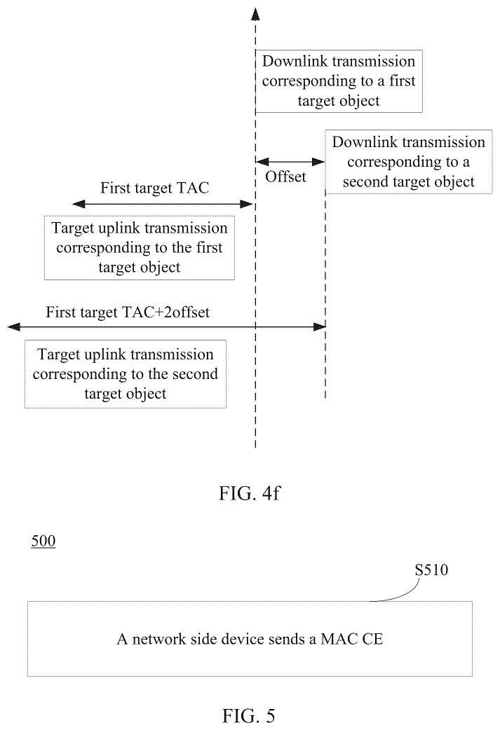

As shown in FIG. 4a, assuming that the first object and the second object share one TA process, the terminal adjusts transmission timing of a physical uplink shared channel (PUSCH) 1 (namely, the target uplink transmission corresponding to the first object) and transmission timing of a PUSCH 2 (namely, the uplink transmission corresponding to the second object) based on different slots (a slot 1 to a slot 8 shown in FIG. 4a) of a same uplink frame (UL Frame).

It should be noted that in this case, considering that the first object and the second object share the one TA process, a process in which the terminal determines a TAC corresponding to the target uplink transmission may include: The terminal receives configured grant information of the target uplink transmission corresponding to the first target object, and determines, based on the configured grant information, the first target TAC as the TAC corresponding to the target uplink transmission. For example, the terminal determines, based on the configured grant information of the target uplink transmission, the first target object associated with the target uplink transmission, and determines the first target TAC associated with the first target object as the TAC of the target uplink transmission. In this embodiment, the configured grant information may include a dynamic grant, a configured grant, a Physical Uplink Control Channel (PUCCH), SRS configuration, and the like.

Based on this, in an implementation, an association relationship between the target uplink transmission and the first target object may be configured through any one of the following (21) to (24).

(21) Configured based on first RRC signaling. For example, that a periodic or semi-persistent SRS, or a Physical Uplink Control Channel (PUCCH) is associated with CoresetPoolIndex may be configured by using the first RRC signaling.

(22) Configured based on CoresetPoolIndex associated with a target control resource set (Coreset), where Downlink Control Information (DCI) for scheduling the target uplink transmission is from the target Coreset.

For example, if the first target object includes the first object and the second object, and the target DCI for scheduling the target uplink transmission is from a target Coreset whose associated CoresetPoolIndex is 0, the target uplink transmission is associated with the first object. If the target DCI for scheduling the target uplink transmission is from a target Coreset whose associated CoresetPoolIndex is 1, the target uplink transmission is associated with the second object.

For another example, assuming that the first target object includes the first object and the second object, if the target DCI from the target Coreset whose CoresetPoolIndex is 0 is detected by the terminal, all target uplink transmissions after K time units from detection of a PDCCH occasion of the target DCI are associated with the first object. If the target DCI from the target Coreset whose CoresetPoolIndex is 1 is detected by the terminal, all target uplink transmissions after the K time units from detection of a PDCCH occasion of the target DCI are associated with the second object.

(23) Determined based on a channel group of the target uplink transmission. For example, a target uplink transmission belonging to a channel group 1 is associated with the first object, a target uplink transmission belonging to a channel group 2 is associated with the second object, and so on.

(24) Determined based on a beam of the target uplink transmission. For example, when the beam of the target uplink transmission is a beam X, the target uplink transmission is associated with the first object. When the beam of the target uplink transmission is a beam Y, the target uplink transmission is associated with the second object. The beam herein may refer to a TCI state. X may represent a first TCI state, and Y may represent a second TCI state.

Further, after determining the TAC (for example, the first target TAC) corresponding to the target uplink transmission, the terminal may periodically adjust the timing of the target uplink transmission corresponding to the first target object. The following describes its implementation process with reference to (31) and (32). It is assumed that the first target object includes the first object and the second object, and the first target TAC includes the first TAC associated with the first object and the second TAC associated with the second object.

(31) Adjust, based on the first TAC in a running period of a first periodical timer, the timing of the target uplink transmission corresponding to the first object, restart the first periodical timer when the first periodical timer expires, and adjust, based on the second TAC in the running period of the first periodical timer after restart, the timing of the target uplink transmission corresponding to the second object, where first start of the first periodical timer is related to start of a first Time Alignment Timer (TAT). Therefore, the first periodical timer is repeatedly started, to implement periodic adjustment of the uplink transmission timing corresponding to the first object and the timing of the target uplink transmission corresponding to the second object.

For example, refer to FIG. 4b. One first periodical timer is defined in this embodiment. Based on this, the terminal starts the first periodical timer (for example, a TAT 1) while starting the first TAT. In this case, in a first running period of the TAT 1, the terminal adjusts, based on the first TAC, the timing of the target uplink transmission corresponding to the first object. If the TAT 1 expires, the TAT 1 is restarted, and in a second running period of the TAT 1, the terminal adjusts, based on the second TAC, the timing of the target uplink transmission corresponding to the second object. In this repeating manner, adjustment of the timing of the target uplink transmissions corresponding to the first object and the second object is implemented.

(32) The terminal adjusts, based on the first TAC in a running period of a second periodical timer, the timing of the target uplink transmission corresponding to the first object, and adjusts, based on the second TAC in a running period of a third periodical timer, the timing of the target uplink transmission corresponding to the second object, where the second periodical timer and the third periodical timer alternately run, and first start of the second periodical timer is related to start of the first TAT.

For example, refer to FIG. 4c. One second periodical timer and one third periodical timer are defined in this embodiment. Based on this, the terminal starts the second periodical timer (for example, a TAT 2) while starting the first TAT. In this case, in a running period of the TAT 2, the terminal adjusts, based on the first TAC, the timing of the target uplink transmission corresponding to the first object. If the TAT 2 expires, the third periodical timer (for example, a TAT 3) is started, and in a running period of the TAT 3, the terminal adjusts, based on the second TAC, the timing of the target uplink transmission corresponding to the second object. In this repeating manner, separate adjustment of the uplink transmission timing corresponding to the first object and the second object is implemented. A timing length of the second periodical timer may be the same as or different from a timing length of the third periodical timer.

It should be noted that the first TAT is started when the terminal receives a MAC CE and the MAC CE includes the first TAC and the second TAC, or the first TAT is started when the terminal receives the first TAC or the second TAC, or the first TAT is a restarted TAT, or the like. The first object and the second object correspond to the same first TAT. That is, the terminal adjusts, based on the same TA process, the timing of the target uplink transmissions corresponding to the first object and the second object.

### Case 2

As shown in FIG. 4d, assuming that the first object and the second object separately correspond to an independent TA process, for example, respectively correspond to a TA process 1 and a TA process 2, the terminal adjusts transmission timing of a PUSCH 1 (namely, the target uplink transmission corresponding to the first object) and transmission timing of a PUSCH 2 (namely, the uplink transmission corresponding to the second object) based on different UL frames.

Based on this, considering that the terminal starts a TAT (that is, a second TAT) when receiving a MAC CE, and the first object and the second object correspond to different TATs (that is, a second TAT corresponding to the first object and a second TAT corresponding to the second object are different), if a second TAT corresponding to a third target object (the first object or the second object) expires, the terminal may execute any one of the following (41) or (42).

(41) Release (or clear) all uplink transmissions sent to the third target object, where the all uplink transmissions may include but are not limited to a Hybrid Automatic Repeat Request (HARQ) transmission, an SRS, a PUCCH, a Configured Grant (CG), Semi-Persistent Scheduling (SPS), Semi-Persistent Channel State Information (SP-CSI), and the like.

(42) Release a first signal sent to the third target object, where the first signal includes at least one of an SRS, a PUCCH, a CG, SPS, or SP-CSI.

Correspondingly, if both the second TAT corresponding to the first object and the second TAT corresponding to the second object expire, the terminal may release all uplink transmissions sent to the first object and the second object.

In addition, considering that the first object and the second object separately correspond to an independent TA process, when adjusting the timing of the target uplink transmission, the terminal may introduce a TA process identifier (process ID) to distinguish between the two TA processes, such as i=CoresetPoolIndex or i=Physical Cell Identifier (PCI).

For example, adjusted timing N_{TA}_{_{new}} (i) may be shown in Formula (1).

$${N}_{{TA}_{new}} ( i ) = {N}_{{TA}_{old}} ( i ) + ( {T}_{A} ( i ) - 31 ) * 16 * 64 / {2}^{μ} \qquad ( 1 )$$

N_{TA}_{_{new}} (i) is the adjusted timing of the target uplink transmission. N_{TA}_{_{old}} (i) is unadjusted timing of the target uplink transmission. T_{A}(i) is a TA indicated by the TAC. i is the TA process ID. Based on this, if the timing of the target uplink transmission corresponding to the first object is adjusted, i=1. If the timing of the target uplink transmission corresponding to the second object is adjusted, i=2. μ represents a subcarrier spacing. In this embodiment, u is a positive integer, such as 1, 2, 3, or the like.

It should be noted that in an implementation, before receiving the MAC CE, the terminal may further receive second RRC signaling. The second RRC signaling may include at least one of the following (51) or (52).

(51) Configuration information of a target timing advance group (TAG), where the configuration information of the target TAG includes a plurality of sets of TA configuration-related information associated with different target objects. The target TAG may be applied to a carrier aggregation scenario, and is used to adjust a problem of different transmission delays due to introduction of a plurality of carriers, or adjust a problem of different transmission delays due to large location differences between primary cells (Primary Cell, Pcell) of different carriers and between secondary cells (Secondary Cell, Scell) of different carriers. In this embodiment, each set of TA configuration-related information may include at least a plurality of TATs, information about an object (for example, the first object or the second object) associated with each TAT.

(52) Configuration information of a target secondary cell, where the configuration information of the target Scell includes configuration information of a plurality of target TAGs corresponding to different target TAGs.

Therefore, when receiving the TAC, the terminal may determine the TAC or the TA based on the configuration information of the target TAG and/or the configuration information of the target secondary cell. This is not limited in this embodiment.

### Example 2

Assuming that the target manner includes the manner 1 and manner 2, as shown in FIG. 4e, the terminal may adjust, based on the first target TAC by using downlink transmission timing of the first target object as a reference (or a basic), the timing of the target uplink transmission corresponding to the first target object, and adjust, based on the first target TAC and the downlink time difference (a difference between the downlink transmission timing corresponding to the first target object and downlink transmission timing corresponding to the second target object), the timing of the target uplink transmission corresponding to the second target object.

In some embodiments, as shown in FIG. 4f, the terminal may adjust, based on the first target TAC by using the downlink transmission timing of the second target object as a basic, the timing of the target uplink transmission corresponding to the first target object, and adjust, based on the first target TAC and the downlink time difference (the difference between the downlink transmission timing corresponding to the first target object and the downlink transmission timing corresponding to the second target object), the timing of the target uplink transmission corresponding to the second target object.

It may be understood that, by using FIG. 4e as an example, when the terminal adjusts, based on the first target TAC, the timing of the target uplink transmission corresponding to the first target object, adjusted timing of the target uplink transmission may be shown in Formula (2).

$${N}_{{TA}_{new}} = {N}_{{TA}_{old}} + ( {T}_{A} - 31 ) * 16 * 64 / {2}^{μ} \qquad ( 2 )$$

N_{TA}_{_{new}} is the adjusted timing of the target uplink transmission corresponding to the first target object. N_{TA}_{_{old}} is unadjusted timing of the target uplink transmission corresponding to the first target object. T_{A} is a TA indicated by the first target TAC. μ represents a subcarrier spacing. In this embodiment, u is a positive integer, such as 1, 2, 3, or the like.

When the terminal adjusts, based on the downlink time difference and the first target TAC, the timing of the target uplink transmission corresponding to the second target object, the adjusted timing of the target uplink transmission may be shown in Formula (3).

$${N}_{{TA}_{new}} = {N}_{{TA}_{old}} + ( {T}_{A} - 31 ) * 16 * 64 / {2}^{μ} + Offset \qquad ( 3 )$$

N_{TA}_{_{new}} is the adjusted timing of the target uplink transmission corresponding to the second target object. N_{TA}_{_{old}} is the unadjusted timing of the target uplink transmission corresponding to the second target object. TA is the TA indicated by the first target TAC. offset is the downlink time difference. i=2. μ represents the subcarrier spacing. In this embodiment, u is a positive integer, such as 1, 2, 3, or the like.

It should be noted that the first target TAC included in a MAC CE is determined based on a downlink frame of the first target object. In other words, the TAC carried in the MAC CE is the first target TAC corresponding to the first target object.

For Example 2, for a same target object (such as the first target object), if the MAC CE carries CoresetPoolindex, the terminal replaces a saved MAC CE with the received MAC CE, even if different CoresetPoolindex is carried.

Further, for Example 1 and Example 2, considering that the terminal needs to adjust the timing of the target uplink transmission within application duration of the first target TAC, to improve communication performance, the terminal performs at least one of the following (61) to (63) within the application duration of the first target TAC.

(61) Not expect to receive uplink transmission scheduling information of an object other than the first target object associated with the first target TAC.

(62) Determine a second signal generated within the application duration of the first target TAC as the target uplink transmission corresponding to the first target object, where the second signal includes at least one of an SRS, a PUCCH, or a CG. That is, the SRS, the PUCCH, and the CG that are generated in TAC application duration of one first target object are all sent to the first target object. In some embodiments, when the terminal sends the second signal, a beam uses a common beam corresponding to the first target object. The common beam herein is a currently applied TCI state.

(63) Ensure that an interval between two PUSCHs scheduled by two target objects is at least one slot, to ensure that performance of a latter PUSCH is not reduced due to shortening of slots.

In addition, when a time interval between an application moment of the first target TAC and an application moment of a previous applied TAC is less than the TA adjustment granularity, the terminal delays the application moment of the first target TAC, so that the time interval between the application moment of the first target TAC and the application moment of the previous applied TAC is greater than or equal to the TA adjustment granularity; and performs, based on a delayed application moment of the first target TAC, the step of adjusting the timing of the target uplink transmission based on the target manner and/or the TA adjustment granularity. In other words, in this application, the terminal does not expect that an interval between application moments of two adjacent TACs is less than the TA adjustment granularity.

In this embodiment, uplink transmissions of two objects can be adjusted by using an independent TA separately, which ensures that arrival timing of uplink transmissions of different users on each object is the same or within one CP. Therefore, interference between the users is effectively reduced, and uplink transmission performance is improved.

FIG. 5 is a schematic flowchart of an uplink transmission method 500 according to an example embodiment of this application. The method 500 may be performed by but is not limited to a network side device, and may be performed by software or/and hardware installed in the network side device. The method 500 includes at least the following steps.

S510: The network side device sends a MAC CE.

The MAC CE includes at least one of the following: a first target timing advance command TAC, where the first target TAC is associated with a first target object; or an identifier of the first target object.

In some embodiments, the method further includes: sending configured grant information of a target uplink transmission corresponding to the first target object. The configured grant information is used by a terminal to determine a TAC corresponding to the target uplink transmission.

In some embodiments, the method further includes: sending second RRC signaling. The second RRC signaling includes at least one of the following: configuration information of a target timing advance group TAG, where the configuration information of the target TAG includes a plurality of sets of TA configuration-related information associated with different target objects; or configuration information of a target secondary cell Scell, where the configuration information of the target Scell includes configuration information of a plurality of target TAGs corresponding to different target TAGs.

In some embodiments, the method further includes: receiving at least one of the following reported by the terminal: UE capability information, where the UE capability information includes that the terminal supports a TA adjustment mode corresponding to one TA, and/or the terminal supports TA adjustment modes corresponding to a plurality of TAs; a quantity of TAs preferred by the terminal, where the quantity of TAs is determined by the terminal based on downlink measurement; or a downlink time difference, where the downlink time difference is determined by the terminal based on the downlink measurement.

It may be understood that the method embodiment 500 has a same or corresponding technical feature as the foregoing method embodiments 200 and 300. Therefore, for an implementation process of the method embodiment 500, reference may be made to related descriptions in the method embodiments 200 and 300, and the same or corresponding technical feature is reached. To avoid repetition, details are not described herein again.

The uplink transmission method provided in this embodiment of this application may be performed by an uplink transmission apparatus. In embodiments of this application, an example in which the uplink transmission method is performed by the uplink transmission apparatus is used to describe the uplink transmission apparatus provided in embodiments of this application.

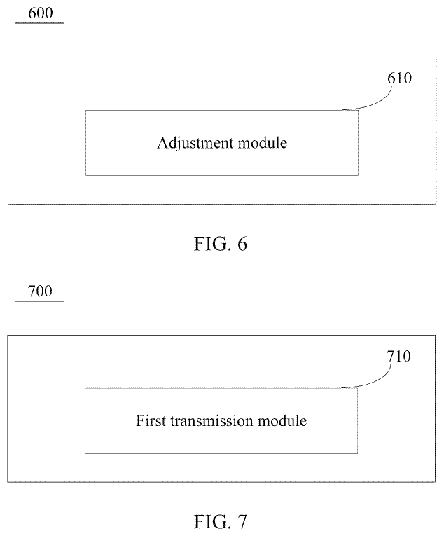

FIG. 6 is a schematic diagram of a structure of an uplink transmission apparatus 600 according to an example embodiment of this application. The apparatus 600 includes: an adjustment module 610, configured by a terminal to adjust timing of a target uplink transmission based on a target manner and/or a timing advance TA adjustment granularity. The target manner includes at least one of the following: adjusting, based on a first target timing advance command TAC, timing of a target uplink transmission corresponding to a first target object; or adjusting, based on a downlink time difference and the first target TAC, timing of a target uplink transmission corresponding to a second target object. The downlink time difference is a difference between first downlink transmission timing and second downlink transmission timing. The first downlink transmission timing is time at which the terminal receives a downlink transmission corresponding to the first target object. The second downlink transmission timing is time at which the terminal receives a downlink transmission corresponding to the second target object. The first target TAC is associated with the first target object.

In some embodiments, the apparatus 600 further includes: a determining module, configured to determine the target manner.

In some embodiments, the apparatus 600 further includes: a second transmission module, configured to receive a media access control control unit MAC CE. The MAC CE includes at least one of the following: the first target TAC; or an identifier of the first target object.

In some embodiments, the step of adjusting, by the adjustment module 610 based on the first target TAC, the timing of the target uplink transmission corresponding to the first target object includes: When the first target object includes a first object and a second object, and the first target TAC includes a first TAC associated with the first object and a second TAC associated with the second object, the terminal calculates a first TA based on the first TAC, and calculates a second TA based on the second TAC; and adjusts, based on the first TA, timing of a target uplink transmission corresponding to the first object, and adjusts, based on the second TA, timing of a target uplink transmission corresponding to the second object.

In some embodiments, the step of adjusting, by the adjustment module 610 based on the first TA, the timing of the target uplink transmission corresponding to the first object, and adjusting, based on the second TA, the timing of the target uplink transmission corresponding to the second object includes any one of the following: adjusting, based on downlink transmission timing corresponding to a reference object and the first TA, the timing of the target uplink transmission corresponding to the first object, and adjusting, based on the downlink transmission timing corresponding to the reference object and the second TA, the timing of the target uplink transmission corresponding to the second object, where the reference object is the first object or the second object; and adjusting, based on downlink transmission timing of the first object and the first TA, the timing of the target uplink transmission corresponding to the first object, and adjusting, based on downlink transmission timing of the second object and the second TA, the timing of the target uplink transmission corresponding to the second object.

In some embodiments, the second transmission module is further configured to receive configured grant information of the target uplink transmission corresponding to the first target object. The adjustment module 610 is further configured to determine, based on the configured grant information, the first target TAC as a TAC corresponding to the target uplink transmission.

In some embodiments, the step of determining, by the adjustment module 610 based on the configured grant information, the TAC corresponding to the target uplink transmission includes: determining, based on the configured grant information of the target uplink transmission, the first target object associated with the target uplink transmission; and determining the first target TAC associated with the first target object as the TAC of the target uplink transmission.

An association relationship between the target uplink transmission and the first target object is configured through any one of the following: configured based on first radio resource control RRC signaling; configured based on a resource pool index CoresetPoolIndex associated with a target control resource set Coreset, where downlink control information DCI for scheduling the target uplink transmission is from the target Coreset; determined based on a channel group of the target uplink transmission; and determined based on a beam of the target uplink transmission.

For example, that an SRS resource is associated with a target object or an SRS resource set is associated with a target object is configured by using RRC, or that a PUCCH resource is associated with a target object or a PUCCH resource group is associated with a target object is configured by using RRC, or the like.

In some embodiments, the association relationship between the target uplink transmission and the first target object is determined in the following manner:

The first target object is determined based on a third object associated with the target uplink transmission, where the third object is associated with the first target object. In other words, the first target object is the first target object associated with the third object of target uplink transmission, and an association relationship between the third object and the first target object may be configured by using RRC.

The first target object is determined based on a target object other than a target object associated with a fourth object, where the fourth object is an object associated with a specific event. For example, the first target object is a target object other than the target object associated with the fourth object, and the specific event is a beam failure.

The third object and the fourth object may be represented as an SRS resource, an SRS resource set, a power control parameter set, a Beam Failure Detection Reference Signal (BFD-RS) set, a reference signal (Synchronization Signaling Block (SSB), a Channel State Information Reference Signal (CSI-RS), a phase reference signal (Tracking Reference Signal, TRS), a BFD-RS, a Path Loss Reference Signal (PL-RS), or the like), or the like.

For example, the power control parameter set is associated with a target object, and a target object associated with an uplink transmission is a target object associated with a power control parameter set associated with the target uplink transmission.

For example, when a beam failure associated with the fourth object is detected by UE, it is considered that a PUCCH resource corresponding to the beam failure is associated with the first target object other than the target object associated with the fourth object. An advantage of this is that when a beam of a TRP fails, it is considered that a PUCCH resource associated with the beam failure is associated with another TRP that does not fail, to ensure performance of PUCCH transmission, so that beam failure information can be reported to a network.

In some embodiments, the step of adjusting, by the adjustment module 610 based on the first target TAC, the timing of the target uplink transmission corresponding to the first target object includes: periodically adjusting, based on the first target TAC, the timing of the target uplink transmission corresponding to the first target object.

In some embodiments, the first target object includes the first object and the second object. The first target TAC includes the first TAC associated with the first object and the second TAC associated with the second object. The step of periodically adjusting, by the adjustment module 610 based on the first target TAC, the timing of the target uplink transmission corresponding to the first target object includes any one of the following: adjusting, based on the first TAC in a running period of a first periodical timer, the timing of the target uplink transmission corresponding to the first object, restarting the first periodical timer when the first periodical timer expires, and adjusting, based on the second TAC in the running period of the first periodical timer after restart, the timing of the target uplink transmission corresponding to the second object, where first start of the first periodical timer is related to start of a first TAT; and adjusting, based on the first TAC in a running period of a second periodical timer, the timing of the target uplink transmission corresponding to the first object, and adjusting, based on the second TAC in a running period of a third periodical timer, the timing of the target uplink transmission corresponding to the second object, where the second periodical timer and the third periodical timer alternately run, and first start of the second periodical timer is related to start of the first TAT. The first TAT is started when the terminal receives the MAC CE, and the MAC CE includes the first TAC and the second TAC. The first object and the second object correspond to the same first TAT.

In some embodiments, the adjustment module 610 is further configured to: when a second TAT corresponding to a third target object expires, perform any one of the following: releasing all uplink transmissions sent to the third target object; and releasing a first signal sent to the third target object, where the first signal includes at least one of a sounding reference signal SRS, a physical uplink control channel PUCCH, a configured grant CG, semi-persistent scheduling SPS, and semi-persistent channel state information SP-CSI. The third target object is the first object or the second object. The second TAT is started when the terminal receives the MAC CE. A second TAT corresponding to the first object and a second TAT corresponding to the second object are different.

In some embodiments, the adjustment module 610 is further configured to: when both the second TAT corresponding to the first object and the second TAT corresponding to the second object expire, release all uplink transmissions sent to the first object and the second object.

In some embodiments, the second transmission module is further configured to receive second RRC signaling. The second RRC signaling includes at least one of the following: configuration information of a target timing advance group TAG, where the configuration information of the target TAG includes a plurality of sets of TA configuration-related information associated with different target objects; and configuration information of a target secondary cell Scell, where the configuration information of the target Scell includes configuration information of a plurality of target TAGs corresponding to different target TAGs.

In some embodiments, the step of adjusting, by the adjustment module 610 based on the first target TAC, the timing of the target uplink transmission corresponding to the first target object includes: N_{TA}_{_{new}}=N_{TA}_{_{old}}+(T_{A}−31)*16*64/2^{μ} N_{TA}_{_{new}} is adjusted timing of the target uplink transmission corresponding to the first target object. N_{TA}_{_{old}} is unadjusted timing of the target uplink transmission corresponding to the first target object. T_{A} is a TA indicated by the first target TAC.

In some embodiments, the step of adjusting, by the adjustment module 610 based on the downlink time difference and the first target TAC, the timing of the target uplink transmission corresponding to second the target object includes: N_{TA}_{_{new}}=N_{TA}_{_{old}}+(T_{A}−31)*16*64/2^{μ}+offset. N_{TA}_{_{new}} is adjusted timing of the target uplink transmission corresponding to the second target object. N_{TA}_{_{old}} is unadjusted timing of the target uplink transmission corresponding to the second target object. T_{A} is a TA indicated by the first target TAC. offset is the downlink time difference.

In some embodiments, the first target TAC included in the MAC CE is determined based on the downlink frame of the first target object.

In some embodiments, the adjustment module 610 is further configured to replace a saved MAC CE with the received MAC CE.

In some embodiments, the second transmission module is further configured to report at least one of the following: UE capability information, where the UE capability information includes that the terminal supports a TA adjustment mode corresponding to one TA, and/or the terminal supports TA adjustment modes corresponding to a plurality of TAs; a quantity of TAs preferred by the terminal, where the quantity of TAs is determined by the terminal based on downlink measurement; and the downlink time difference, where the downlink time difference is determined by the terminal based on the downlink measurement.

In some embodiments, the adjustment module 610 is further configured by the terminal to periodically adjust the timing of the target uplink transmission based on the TA adjustment granularity.

In some embodiments, the TA adjustment granularity is determined based on any one of the following manners: determined autonomously by the terminal; and determined based on a third RRC signaling received by the terminal, where the TA adjustment granularity is configured in the third RRC signaling.

In some embodiments, UE determines, based on a measured downlink time difference associated with different target objects, the TA adjustment granularity, and reports the TA adjustment granularity to the network. The UE reports information about the TA adjustment granularity, which helps the network reduce ineffective uplink scheduling.

In some embodiments, an interval between target uplink transmissions associated with different target objects cannot be less than the TA adjustment granularity. The terminal does not expect that when the network schedules two uplink transmissions associated with different target objects, an interval between the uplink transmissions is less than the TA adjustment granularity. If the interval is less than the TA adjustment granularity, the terminal cannot adjust a TA in time, which causes an uplink transmission failure.

In some embodiments, the adjustment module 610 is further configured to select a target uplink transmission associated with a fourth target object for transmission, and discard a target uplink transmission associated with another target object, when target uplink transmissions associated with different target objects meet at least one of the following conditions. The condition includes: time domain resources of different uplink transmissions overlap; or
a time domain interval between different uplink transmissions is less than the TA adjustment granularity.

In some embodiments, the third target object may be indicated by DCI signaling. An advantage of this is that the UE may be dynamically indicated to select an uplink transmission for transmission. For example, an uplink transmission of a high priority may be indicated for transmission. In some embodiments, a transmission priority may be indicated by using an indication field in the DCI.

In some embodiments, the adjustment module 610 is further configured to: when a time interval between an application moment of the first target TAC and an application moment of a previous applied TAC is less than the TA adjustment granularity, delay the application moment of the first target TAC, and perform, based on a delayed application moment of the first target TAC, the step of adjusting the timing of the target uplink transmission based on the target manner and/or the TA adjustment granularity.

In some embodiments, the apparatus 600 further includes a processing module. Within application duration of the first target TAC, the processing module is configured to perform at least one of the following: not expecting to receive uplink transmission scheduling information of an object other than the first target object associated with the first target TAC; and determining a second signal generated within the application duration of the first target TAC as the target uplink transmission corresponding to the first target object, where the second signal includes at least one of an SRS, a PUCCH, and a CG.

The uplink transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), or the like. This is not specifically limited in this embodiment of this application.

The uplink transmission apparatus 600 provided in this embodiment of this application can implement the processes implemented in the method embodiments of FIG. 2 and FIG. 3, and the same technical effect is achieved. To avoid repetition, details are not described herein again.

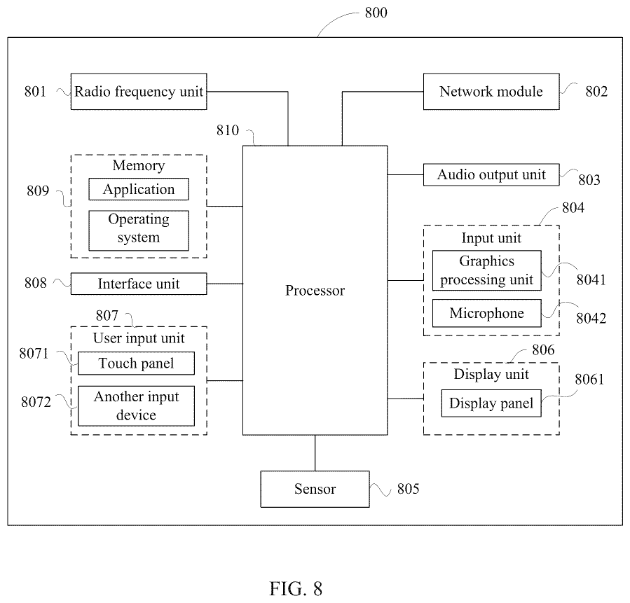

FIG. 7 is a schematic diagram of a structure of an uplink transmission apparatus 700 according to an example embodiment of this application. The apparatus 700 includes: a first transmission module 710, configured to send a media access control control unit MAC CE. The MAC CE includes at least one of the following: a first target timing advance command TAC, where the first target TAC is associated with a first target object; and an identifier of the first target object.

In some embodiments, the first transmission module 710 is configured to send configured grant information of a target uplink transmission corresponding to the first target object. The configured grant information is used by a terminal to determine a TAC corresponding to the target uplink transmission.

In some embodiments, the first transmission module 710 is configured to send second RRC signaling. The second RRC signaling includes at least one of the following: configuration information of a target timing advance group TAG, where the configuration information of the target TAG includes a plurality of sets of TA configuration-related information associated with different target objects; and configuration information of a target secondary cell Scell, where the configuration information of the target Scell includes configuration information of a plurality of target TAGs corresponding to different target TAGs.

In some embodiments, the apparatus 700 further includes: the first transmission module 710, configured to receive at least one of the following reported by the terminal: UE capability information, where the UE capability information includes that the terminal supports a TA adjustment mode corresponding to one TA, and/or the terminal supports TA adjustment modes corresponding to a plurality of TAs; a quantity of TAs preferred by the terminal, where the quantity of TAs is determined by the terminal based on downlink measurement; and a downlink time difference, where the downlink time difference is determined by the terminal based on the downlink measurement.

The uplink transmission apparatus 700 in this embodiment of this application may be a network side device, or may be a component in the network side device, such as an integrated circuit or a chip. For example, the network side device may include but is not limited to the types of network side devices 12 listed above. This is not specifically limited in this embodiment of this application.

The uplink transmission apparatus 700 provided in this embodiment of this application can implement the processes implemented in the method embodiment of FIG. 5, and the same technical effect is achieved. To avoid repetition, details are not described herein again.

An embodiment of this application further provides a terminal. The terminal includes a processor and a communication interface. The communication interface is coupled to the processor. The processor is configured to run a program or an instruction to implement the steps of the methods according to the method embodiments 200 and 300. This terminal embodiment corresponds to the foregoing terminal side method embodiment. Each implementation process and implementation of the foregoing method embodiment may be applicable to this terminal embodiment, and the same technical effect can be achieved. FIG. 8 is a schematic diagram of a hardware structure of a terminal for implementing an embodiment of this application.

The terminal 800 includes but is not limited to at least a part of components of a radio frequency unit 801, a network module 802, an audio output unit 803, an input unit 804, a sensor 805, a display unit 806, a user input unit 807, an interface unit 808, a memory 809, a processor 810, and the like.

A person skilled in the art can understand that the terminal 800 may further include a power supply (such as a battery) that supplies power to each component. The power supply may be logically connected to the processor 810 by using a power management system, to implement functions such as charging and discharging management, and power consumption management by using the power management system. The terminal structure shown in FIG. 8 constitutes no limitation on the terminal, and the terminal may include more or fewer components than those shown in the figure, or combine some components, or have different component arrangements. Details are not described herein.

It should be understood that in this embodiment of this application, the input unit 804 may include a Graphics Processing Unit (GPU) 8041 and a microphone 8042. The graphics processing unit 8041 processes image data of a static picture or a video obtained by an image capture apparatus (for example, a camera) in a video capture mode or an image capture mode. The display unit 806 may include a display panel 8061, and the display panel 8061 may be configured in a form of liquid crystal display, organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Usually, the radio frequency unit 801 includes but is not limited to an antenna, an amplifier, a transceiver, a coupler, a low-noise amplifier, a duplexer, and the like.

The memory 809 may be configured to store a software program or an instruction and various data. The memory 809 may mainly include a first storage area for storing the program or the instruction and a second storage area for storing the data. The first storage area may store an operating system, an application or an instruction required by at least one function (for example, a sound playing function or an image playing function), and the like. In addition, the memory 809 may be a volatile memory or a non-volatile memory, or the memory 809 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 809 in this embodiment of this application includes but is not limited to these memories and any memory of another proper type.

The processor 810 may include one or more processing units. In some embodiments, an application processor and a modem processor are integrated into the processor 810. The application processor mainly processes operations related to an operating system, a user interface, an application, and the like. The modem processor mainly processes a wireless communication signal, for example, a baseband processor. It may be understood that, the modem processor may not be integrated into the processor 810.

The processor 810 is configured by the terminal to adjust timing of a target uplink transmission based on a target manner and/or a timing advance TA adjustment granularity. The target manner includes at least one of the following: adjusting, based on a first target timing advance command TAC, timing of a target uplink transmission corresponding to a first target object; and adjusting, based on a downlink time difference and the first target TAC, timing of a target uplink transmission corresponding to a second target object. The downlink time difference is a difference between first downlink transmission timing and second downlink transmission timing. The first downlink transmission timing is time at which the terminal receives a downlink transmission corresponding to the first target object. The second downlink transmission timing is time at which the terminal receives a downlink transmission corresponding to the second target object. The first target TAC is associated with the first target object.

In this embodiment, the terminal adjusts the timing of the target uplink transmission based on the target manner and/or the TA adjustment granularity. The target manner includes: adjusting, based on the first target TAC, the timing of the target uplink transmission corresponding to the first target object; and/or adjusting, based on the downlink time difference and the first target TAC, the timing of the target uplink transmission corresponding to the second target object. In this way, different target objects use different TAs to adjust uplink transmission timing, to ensure accurate and efficient adjustment of the uplink transmission timing, so as to ensure that uplink transmission timing corresponding to each target object meets an orthogonal relationship between users, avoid interference between the users, and improve uplink transmission performance. In addition, adjusting the timing of the target uplink transmission based on the TA adjustment granularity can avoid problems of high terminal power consumption and high signaling overheads caused by frequent adjustment, and can also reduce complexity of terminal implementation.

An embodiment of this application further provides a network side device. The network side device includes a processor and a communication interface. The communication interface is coupled to the processor. The processor is configured to run a program or an instruction to implement the steps of the method according to the method embodiment 500. This network side device embodiment corresponds to the foregoing network side device method embodiment. Each implementation process and implementation of the foregoing method embodiment may be applicable to this network side device embodiment, and the same technical effect can be achieved.

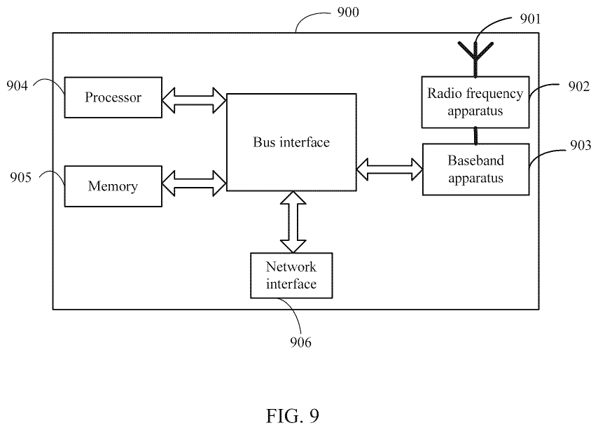

An embodiment of this application further provides a network side device. As shown in FIG. 9, the network side device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information by using the antenna 901, and sends the received information to the baseband apparatus 903 for processing. In a downlink direction, the baseband apparatus 903 processes information that needs to be sent, and sends processed information to the radio frequency apparatus 902. The radio frequency apparatus 902 processes the received information, and sends processed information by using the antenna 901.

In the foregoing embodiment, the method performed by the network side device may be implemented in the baseband apparatus 903, and the baseband apparatus 903 includes a baseband processor.

For example, the baseband apparatus 903 may include at least one baseband board. A plurality of chips are disposed on the baseband board. As shown in FIG. 9, one of the chips is, for example, the baseband processor, and is connected to the memory 905 by using a bus interface, to invoke a program in the memory 905 to perform the operations of the network device shown in the foregoing method embodiment.

The network side device may further include a network interface 906, and the interface is, for example, a common public radio interface (CPRI).

The network side device 900 in this embodiment of this application further includes an instruction or a program that is stored in the memory 905 and that can be run on the processor 904. The processor 904 invokes the instruction or the program in the memory 905 to execute the method performed by the modules shown in FIG. 7, and the same technical effect is achieved. To avoid repetition, details are not described herein again.

An embodiment of this application further provides a readable storage medium. The readable storage medium stores a program or an instruction. When the program or the instruction is executed by a processor, the processes in the foregoing uplink transmission method embodiments are implemented, and the same technical effects can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or an instruction of a network side device, to implement the processes in the foregoing uplink transmission method embodiments, with the same technical effects achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program product. The computer program product includes a processor, a memory, and a program or an instruction that is stored in the memory and that can be run on the processor. When the program or the instruction is executed by the processor, the processes in the foregoing uplink transmission method embodiments are implemented, and the same technical effects can be achieved. To avoid repetition, details are not described herein again.

An embodiment of this application further provides a wireless communication system. The wireless communication system includes a terminal and a network side device. The terminal may be configured to perform the steps in the foregoing method embodiments 200 and 300, and the network side device may be configured to perform the steps in the foregoing method embodiment 500.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of computer software product. The computer software product is stored in a storage medium (for example, a ROM/RAM, a floppy disk, or an optical disc), and includes several instructions for instructing a terminal (which may be a mobile phone, a computer, a server, an air-conditioner, a network device, or the like) to perform the methods described in embodiments of this application.

Embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for uplink transmission, performed by a terminal, comprising:
receiving radio resource control (RRC) signaling, wherein the RRC signaling comprises configuration information of a target timing advance group (TAG), wherein the configuration information of the target TAG comprises a plurality of sets of timing advance (TA) configuration-related information associated with different target objects, wherein each target object comprises a transmission configuration indicator (TCI) state; and
adjusting, based on a first target timing advance command (TAC), timing of a target uplink transmission corresponding to a first target TCI state,
wherein the first target TAC is associated with the first target TCI state.

2. The method according to claim 1, further comprising:
receiving, by the terminal, a media access control control unit (MAC CE),
wherein the MAC CE comprises at least one of the following:
the first target TAC; or
an identifier of a first TAG.

3. The method according to claim 1, wherein adjusting, based on the first target TAC, the timing of the target uplink transmission corresponding to the first target TCI state comprises:
when the first target TCI state comprises a first TCI state and a second TCI state, and a first TAC is associated with the first TCI state and a second TAC is associated with the second TCI state, calculating, by the terminal, a first TA based on the first TAC, and calculating a second TA based on the second TAC; and
adjusting, based on the first TA, timing of a target uplink transmission corresponding to the first TCI state, and adjusting, based on the second TA, timing of a target uplink transmission corresponding to the second TCI state.

4. The method according to claim 3, wherein adjusting, based on the first TA, the timing of the target uplink transmission corresponding to the first TCI state, and adjusting, based on the second TA, the timing of the target uplink transmission corresponding to the second TCI state comprises any one of the following:
adjusting, based on downlink transmission timing corresponding to a reference object and the first TA, the timing of the target uplink transmission corresponding to the first TCI state, and adjusting, based on the downlink transmission timing corresponding to the reference object and the second TA, the timing of the target uplink transmission corresponding to the second TCI state, wherein the reference object is the first TCI or the second TCI state; or
adjusting, based on downlink transmission timing of the first TCI state and the first TA, the timing of the target uplink transmission corresponding to the first TCI state, and adjusting, based on downlink transmission timing of the second TCI state and the second TA, the timing of the target uplink transmission corresponding to the second TCI state.

5. The method according to claim 1, further comprising:
receiving configured grant information of the target uplink transmission corresponding to the first target TCI state; and
determining, based on the configured grant information, the first target TAC as a TAC of the target uplink transmission corresponding to the first target TCI state.

6. The method according to claim 1, wherein adjusting, based on the first target TAC, the timing of the target uplink transmission corresponding to the first target TCI state comprises:
periodically adjusting, based on the first target TAC, the timing of the target uplink transmission corresponding to the first target TCI state.

7. The method according to claim 1, wherein adjusting, based on the first target TAC, the timing of the target uplink transmission corresponding to the first target TCI state comprises:
N_{TA}_{_{new}}=N_{TA}_{_{old}}+(T_{A}−31)*16*64/2^{μ}, wherein
N_{TA}_{_{new}} is adjusted timing of the target uplink transmission corresponding to the first target object, N_{TA}_{_{old}} is unadjusted timing of the target uplink transmission corresponding to the first target TCI state, and T_{A} is a TA indicated by the first target TAC.

8. The method according to claim 1, further comprising:
reporting, by the terminal, at least one of the following:
UE capability information, wherein the UE capability information comprises that the terminal supports a TA adjustment mode corresponding to one TA, or the terminal supports TA adjustment modes corresponding to a plurality of TAs;
a quantity of TAs preferred by the terminal, wherein the quantity of TAs is determined by the terminal based on downlink measurement; or
the downlink time difference, wherein the downlink time difference is determined by the terminal based on the downlink measurement.

9. The method according to claim 1, further comprising:
when time domain resources of target uplink transmissions associated with different target objects overlaps, selecting a target uplink transmission associated with the target object indicated by the DCI signaling for transmission, and discarding a target uplink transmission associated with another target object.

10. The method according to claim 1, further comprising:
within application duration of the first target TAC, the terminal performs at least one of the following:
not expecting to receive uplink transmission scheduling information of a target object other than the first target TCI state associated with the first target TAC; and
determining a second signal generated within the application duration of the first target TAC as the target uplink transmission corresponding to the first target TCI state, wherein the second signal comprises at least one of a sounding reference signal (SRS), a physical uplink control channel (PUCCH), or a configured grant (CG).

11. A method for uplink transmission, comprising:
sending, by a network side device, radio resource control (RRC) signaling, wherein the RRC signaling comprises configuration information of a target timing advance group (TAG), wherein the configuration information of the target TAG comprises a plurality of sets of timing advance (TA) configuration-related information associated with different target objects, wherein each target object comprises a transmission configuration indicator (TCI) state.

12. The method according to claim 11, further comprising:
sending, by the network side device, a media access control control unit (MAC CE),
wherein the MAC CE comprises at least one of the following:
a first target timing advance command (TAC), wherein the first target TAC is associated with a first target TCI state; or
an identifier of a first TAG.

13. The method according to claim 11, further comprising:
receiving, by the network side device, at least one of the following reported by a terminal:
UE capability information, wherein the UE capability information comprises that the terminal supports a TA adjustment mode corresponding to one TA, or the terminal supports TA adjustment modes corresponding to a plurality of TAs;
a quantity of TAs preferred by the terminal, wherein the quantity of TAs is determined by the terminal based on downlink measurement; or
a downlink time difference, wherein the downlink time difference is determined by the terminal based on the downlink measurement.

14. A terminal, comprising: a memory storing a computer program; and a processor coupled to the memory and configured to execute the computer program to perform operations comprising:
receiving radio resource control (RRC) signaling, wherein the RRC signaling comprises configuration information of a target timing advance group (TAG), wherein the configuration information of the target TAG comprises a plurality of sets of timing advance (TA) configuration-related information associated with different target objects, wherein each target object comprises a transmission configuration indicator (TCI) state; and
adjusting, based on a first target timing advance command (TAC), timing of a target uplink transmission corresponding to a first target TCI state,
wherein the first target TAC is associated with the first target TCI state.

15. The terminal according to claim 14, wherein the operations further comprise:
Receiving a media access control control unit (MAC CE),
wherein the MAC CE comprises at least one of the following:
the first target TAC; or
an identifier of a first TAG.

16. The terminal according to claim 14, wherein adjusting, based on the first target TAC, the timing of the target uplink transmission corresponding to the first target TCI state comprises:
when the first target TCI state comprises a first TCI state and a second TCI state, and a first TAC is associated with the first TCI state and a second TAC is associated with the second TCI state, calculating, by the terminal, a first TA based on the first TAC, and calculating a second TA based on the second TAC; and
adjusting, based on the first TA, timing of a target uplink transmission corresponding to the first TCI state, and adjusting, based on the second TA, timing of a target uplink transmission corresponding to the second TCI state.

17. The terminal according to claim 16, wherein adjusting, based on the first TA, the timing of the target uplink transmission corresponding to the first TCI state, and adjusting, based on the second TA, the timing of the target uplink transmission corresponding to the second TCI state comprises any one of the following:
adjusting, based on downlink transmission timing corresponding to a reference object and the first TA, the timing of the target uplink transmission corresponding to the first TCI state, and adjusting, based on the downlink transmission timing corresponding to the reference object and the second TA, the timing of the target uplink transmission corresponding to the second TCI state, wherein the reference object is the first TCI or the second TCI state; or
adjusting, based on downlink transmission timing of the first TCI state and the first TA, the timing of the target uplink transmission corresponding to the first TCI state, and adjusting, based on downlink transmission timing of the second TCI state and the second TA, the timing of the target uplink transmission corresponding to the second TCI state.

18. The terminal according to claim 14, wherein the operations further comprise:
receiving configured grant information of the target uplink transmission corresponding to the first target TCI state; and
determining, based on the configured grant information, the first target TAC as a TAC of the target uplink transmission corresponding to the first target TCI state.

19. The terminal according to claim 14, wherein adjusting, based on the first target TAC, the timing of the target uplink transmission corresponding to the first target TCI state comprises:
periodically adjusting, based on the first target TAC, the timing of the target uplink transmission corresponding to the first target TCI state.

20. The terminal according to claim 14, wherein adjusting, based on the first target TAC, the timing of the target uplink transmission corresponding to the first target TCI state comprises:
N_{TA}_{_{new}}=N_{TA}_{_{old}}+(T_{A}−31)*16*64/2^{μ}, wherein
N_{TA}_{_{new}} is adjusted timing of the target uplink transmission corresponding to the first target object, N_{TA}_{_{old}} is unadjusted timing of the target uplink transmission corresponding to the first target TCI state, and T_{A} is a TA indicated by the first target TAC.
